(19) United States
(12) Patent Application Publication
(10) Pub. No.: US 2014/0331288 A1
(43) Pub. Date: Nov. 6, 2014

(54) ACCESS GATING OF NOISY PHYSICAL FUNCTIONS

(71) Applicant: VERAYO, INC., San Jose, CA (US)

(72) Inventors: Meng-Day (Mandel) YU, Fremont, CA (US); David M'RAIHI, San Jose, CA (US)

(73) Assignee: VERAYO, INC., San Jose, CA (US)

(21) Appl. No.: 14/267,849

(22) Filed: May 1, 2014

Related U.S. Application Data
(60) Provisional application No. 61/817,875, filed on May 1, 2013.

(51) Int. Cl. H04L 29/06

(52) U.S. Cl. CPC H04L 63/08
USPC 726/4

(57) ABSTRACT

A system and methods are disclosed that limiting the number of challenge/response pairs available to an adversary. In accordance with the various aspects of the present invention, gate the access to an authentication module with a gatekeeper. The system can create a challenge/response protocol whereby the amount of challenge/response information leaked is controlled by the server. The device cannot leak challenge/response pairs when the device is in the possession of or being queried by an adversary or false device.

### CROSS REFERENCE

Pursuant to 35 U.S.C. §119 (e), this application claims priority to the filing date of U.S. Provisional Patent Application Ser. No. 61/817,875 filed on May 1, 2013 (Titled ACCESS GATING OF NOISY PHYSICAL FUNCTIONS), the entire disclosures of which application is incorporated herein by reference.

### FIELD OF THE INVENTION

The present invention relates to systems for security and, more specifically, to control of open access system security through limiting challenge/response attacks based on machine learning attacks.

### BACKGROUND

The invention relates to limiting “oracle access” to the challenge/response characteristics of a physical function, to help prevent mathematical attacks such as machine learning attacks. These attacks take advantage of a practically unbounded access of challenge/response pairs to a physical device containing a physical function, to train a mathematical model that mimic the input/output characteristics of a physical function in a mathematical cloning attack.

Physical functions, such as certain Arbiter PUF configurations, can be modeled using machine learning algorithms by obtaining a sufficient number of challenge/response pairs; once the challenge/response pairs are obtained, the attack can occur off-line. It is, therefore, desirable, to limit the amount of challenge/response information that can be used by such an attacker. In “key generation” applications where error correction is applied to remove the PUF noise, only a fixed number of challenges and a fixed number of responses need to be used. The maximum amount of challenge/response information that can possibly be made available to an adversary is bounded because the keying bits generated are bounded.

To date, in authentication applications, where no error correction is applied, there is no published way to limit the number of challenge/response pairs available to an adversary. Therefore, what is needed is a system and method for limiting the number of challenge/response pairs available to an adversary or false device.

### SUMMARY

The present invention provides a system and methods for limiting the number of challenge/response pairs available to an adversary. In accordance with the various aspects of the present invention “Gate” the access to an “Authentication PUF” with a “Gatekeeper PUF.” Therefore, the system can create a challenge/response protocol whereby amount of challenge/response information leaked can be fully controlled by the server from a mathematical and protocol standpoint, and the device cannot arbitrary leak an arbitrary large number of challenge/response pairs when the device is in the possession of or being queried by an adversary or false device.

### DESCRIPTION OF THE DRAWINGS

The drawings are intended to be illustrative, to those of skill in the art, of particular aspects of the invention and are not necessarily to scale and each is not necessarily inclusive of all aspects.

FIG. 1A is a flow process for provisioning using a server.

FIG. 1B is a flow process for provisioning using a device that includes a manufacturing variation sensitive circuit.

FIG. 1C shows a system with a challenge/response pair that includes provisioning using challenges from a server to a device.

FIG. 1D shows the system of FIG. 1C being queried by a false device or adversary.

FIG. 2A is a flow process for provisioning using a server in accordance with the various aspects of the present invention.

FIG. 2B is a flow process for provisioning using a device in accordance with the teachings of the present invention.

FIG. 2C shows a system that includes a manufacturing variation sensitive circuit and a gatekeeper in accordance with the teachings of the present invention.

FIG. 2D shows the system of FIG. 2C being queried by a false device or adversary in accordance with the teachings of the present invention.

FIG. 3 is a flow process for a server authenticating a device in accordance with the various aspects of the present invention.

FIG. 4 is a flow process for a device being authenticated by a server in accordance with the various aspects of the present invention.

FIG. 5 is a system for authenticating and preventing attacks that includes a manufacturing variation sensitive circuit and a gatekeeper in accordance with the teachings of the present invention.

FIG. 6 is a data flow of a specific aspect in accordance with the teachings of the present invention.

### DETAILED DESCRIPTION

The invention can be realized in a wide variety of ways. The figures and description disclosed herein are illustrative of only a small range of possible embodiments of the invention.

As will be apparent to those of skill in the art upon reading this disclosure, each of the aspects described and illustrated herein has discrete components and features which may be readily separated from or combined with the features and aspects to form embodiments, without departing from the scope or spirit of the invention. Any recited method can be carried out in the order of events recited or in any other order which is logically possible.

In accordance with the various aspects and teachings of the present invention a computer and a computing device are articles of manufacture. Other examples of an article of manufacture include: an electronic component residing on a mother board, circuits, a server, a mainframe computer, or other special purpose computer components, each having one or more processors (e.g., a Central Processing Unit, a Graphical Processing Unit, a circuit, or a microprocessor) that is configured to execute code (e.g., an algorithm, hardware, firmware, and/or software) to derive data, receive data, transmit data, store data, or perform methods and steps. The article of manufacture (e.g., computer, circuit, or computing device) includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor, in turn, executes the computer readable program code to create or amend an existing computer-aided design using a tool. In other aspects of the embodiments, the creation or amendment of the computer-aided design is implemented as a web-based software application in which portions of the data related to the computer-aided design or the tool or the computer readable program code are received or transmitted to a computing device or a host, such as a server and associated database.

Therefore, an article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a circuit or a processor.

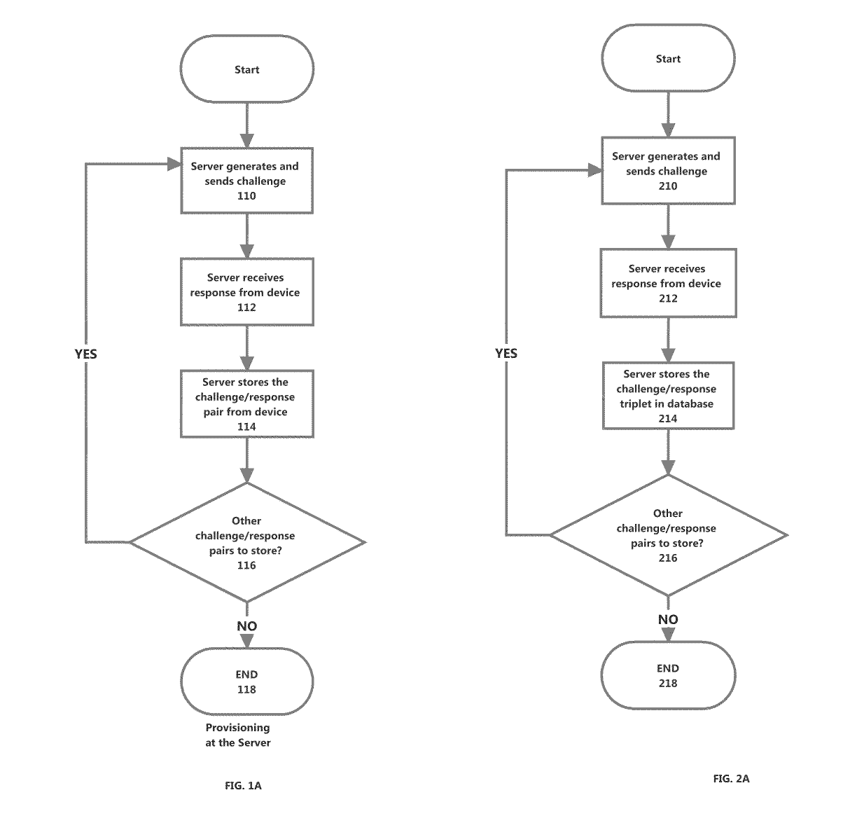

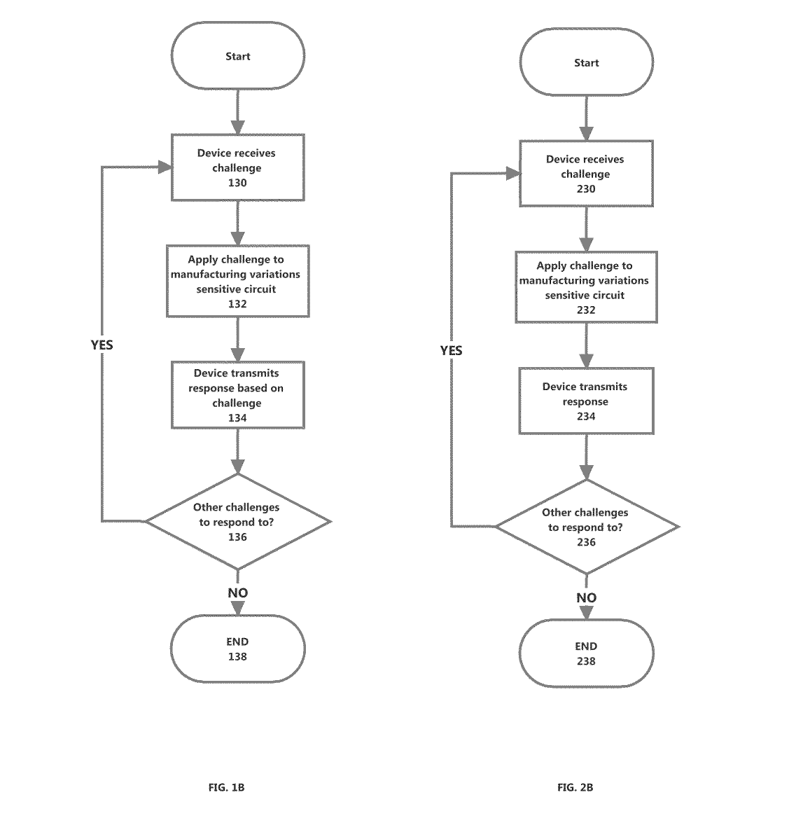

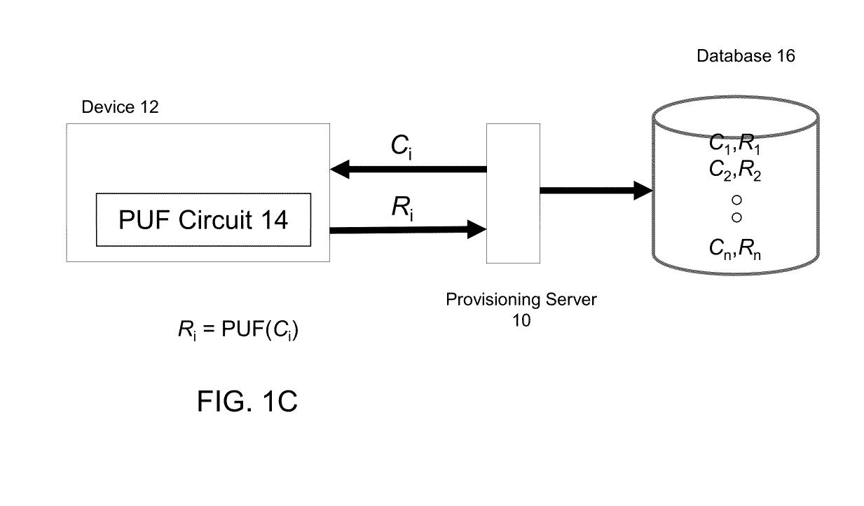

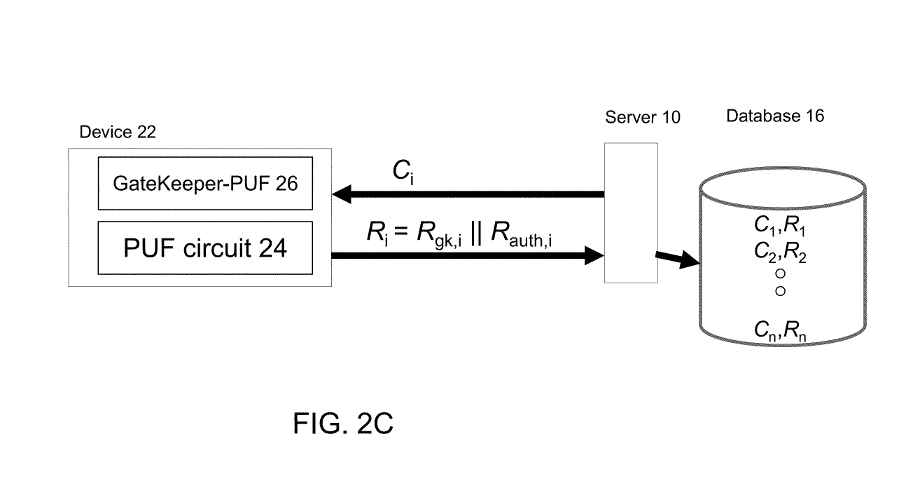

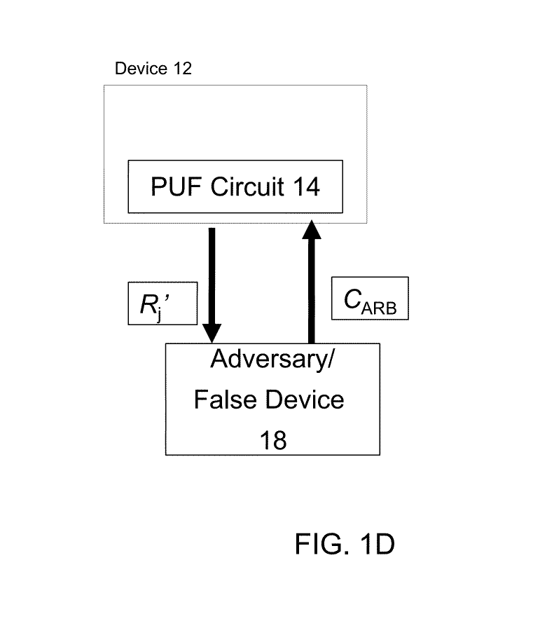

Referring now to FIG. 1A, FIG. 1B, and FIG. 1C, a provisioning server 10, at step 110, generates and sends a challenge (C₁) to a device 12. The device 12 includes a Physical Unclonable Function (PUF) circuit 14, which is a manufacturing variation sensitive circuit.

Referring now to FIG. 1B and FIG. 1C, the device 12 receives the challenge (C₁) at step 130. At step 132, based on the challenge (C₁), the device 12 applies the challenge (C₁) to the PUF circuit 14 and produces a response (R₁). At step 134, the device 12 send the response (R₁) to the server 10. The device 12 determines, at step 136, if other challenges exists and returns to step 130 to process additional challenges; otherwise the process ends at step 138.

Referring to FIG. 1A and FIG. 1C, the server 10, at step 112, receives the response (R1) and, at step 114, stores the challenge (C₁) and the response (R₁) as a challenge/response pair in a database 16. At step 116 the server determines if other challenges are to be generated in order to produce additional challenge/response pairs. If so, then the process is repeated, by returning to step 110, during provisioning to generate as many challenge/response pairs as needed and ends at step 118.

Referring now to FIG. 1D, an adversary or a fake device 18 will attempt to gain information from the device 12. Using the information, as described below, the adversary 18 will attempt to obtain challenge/response pairs from the device in order to obtain material for a mathematical (modeling) attack that can be computed off-line in order to later fool the server by deriving a response to a yet-to-be-seen challenge. The adversary 18 does this by issuing arbitrary challenges (G_{ARB}) to the PUF circuit 14 of the device 12. The adversary will then obtain a corresponding response (R′ⱼ). As shown, the adversary has arbitrary access to the responses of the device to a challenge that can be adaptively chosen by the adversary; the amount of challenge/response information that an adversary 18 can see is unrestricted. Thus, the adversary 18 can send many challenges and receive many responses. Having these pairs of challenges/responses, the adversary 18 can use machine learning to generate the challenge/response pairs that may allow it to be authenticated by the server 10 because the adversary 18 is able to, if the machine learning modeling attack is successful, derive the responses needed based on a challenge from the server 10.

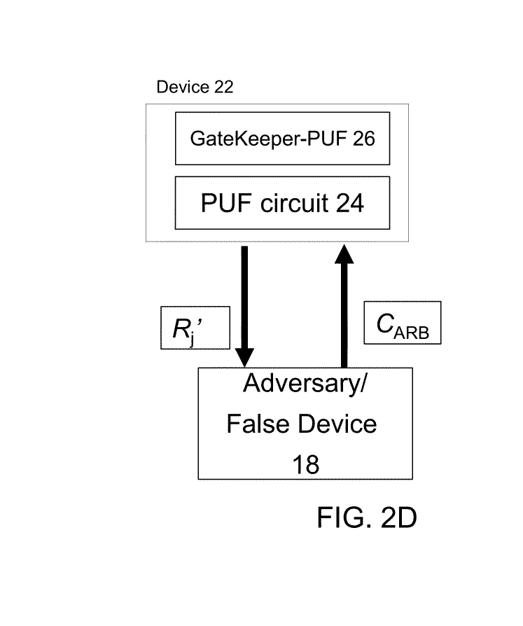

Referring now to FIG. 2A, FIG. 2B, and FIG. 2C, a system is shown that includes a provisioning server 10, a database 16, and a device 22. At step 210, the server generates and sends a challenge (C,) to the device 22. The device 22 includes a PUF circuit 24, which is a manufacturing variation sensitive circuit, and a gatekeeper PUF 26, which is a manufacturing variation sensitive circuit in accordance with some aspects and embodiments of the present invention. At step 210, the server 10 generates and sends a challenge (C₁) to the device 22.

Referring to FIG. 2B and FIG. 2C, the device 22 receives the challenge (Cᵢ) at step 230. At step 232, based on the challenge (Cᵢ), the device 12 applies the challenge (Cᵢ) to the PUF circuit 24 and the gatekeeper 26 and produces a response (Rᵢ). The response (Rᵢ). includes a response produced by the PUF circuit 24 and the gatekeeper 26. At step 234, the device 12 sends the response (Rᵢ) to the server 10. The device 22 determines, at step 236, if other challenges exists and returns to step 230 to process additional challenges; otherwise the process ends at step 238. For simplicity the same challenge is shown to be applied to both PUFs. More generally, the two challenges have to be interlocked.

Referring now to FIG. 2A and FIG. 2C, during a provisioning process, the server 10, at step 212, receives a response (R₁) from the device 22, wherein R₁=R_{gk1} II Rₐᵤₜₕ₁ and wherein:

R_{gk1}=PUFgk(C₁),

Rₐᵤₜₕ₁=PUFauth(C₁),

and the triplet {C₁, R_{gk1}, Rₐᵤₜₕ₁} is stored, at step 214 in the database 16 as {C₁, R₁}. At step 216, if other challenges/responses are needed, then process is repeated by returning to step 210; otherwise the process ends at step 218. The provisioning extraction feature is then disabled, e.g., via a fuse, presence of certain non-volatile initialization parameters, use of one-way functions ,etc.

Referring now to FIG. 2D, after provisioning is complete and device has been fielded, the adversary 18 again can issue arbitrary challenges (G_{ARB}) to the PUF circuit 24 of the device 22. However, for the device to output a legitimate response, the adversary needs to know R_{gk1} associated with the challenge; else the “gate” does not open. If R_{gk1} can be produced, the response R′ⱼ=Rₐᵤₜₕ₁ will be from the PUF circuit 24. Thus, with a gatekeeper 26 and the gating function, the amount of information that the adversary 18 can see is limited. Thus, the server 10 has control of what challenge/response pairs an adversary 18 can extract from the device 22. This limits what the adversary 18 can gather and see from a mathematical and protocol standpoint. Active and adaptive chosen challenge attacks are no longer possible because the adversary 18 no longer has open access to the device 22 to obtain challenge/response pairs; the device can choose to output garbage for R′ⱼ if a proper R_{gk1} is not seen.

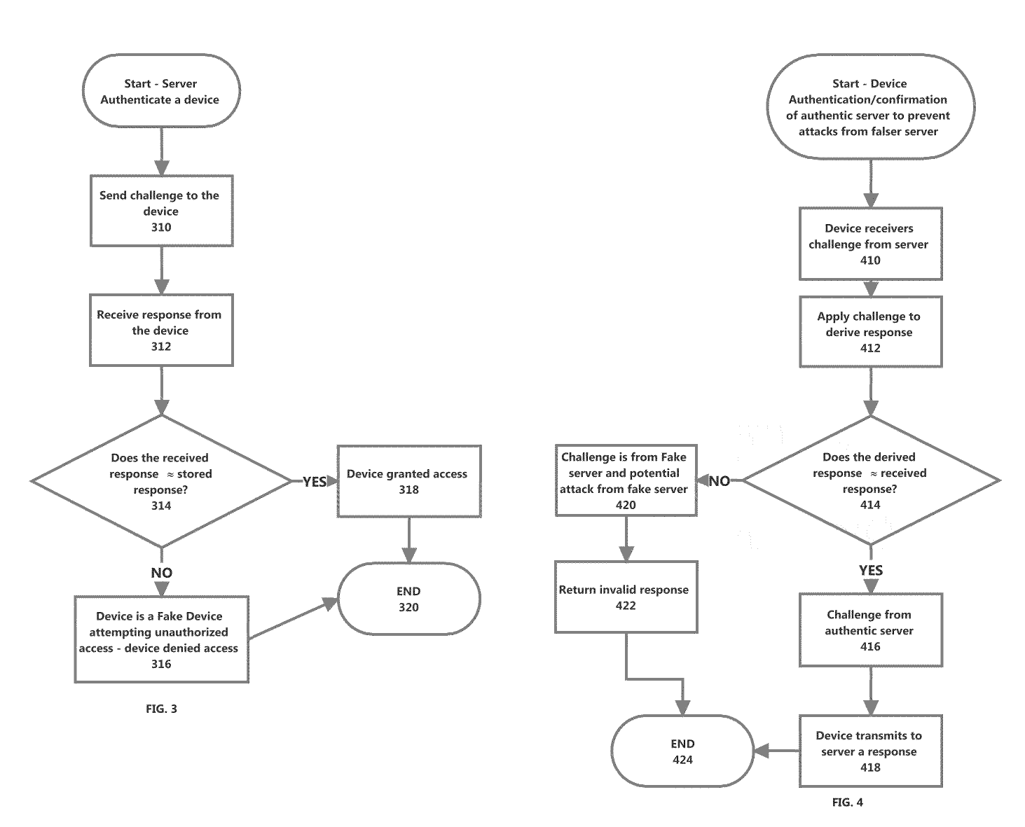

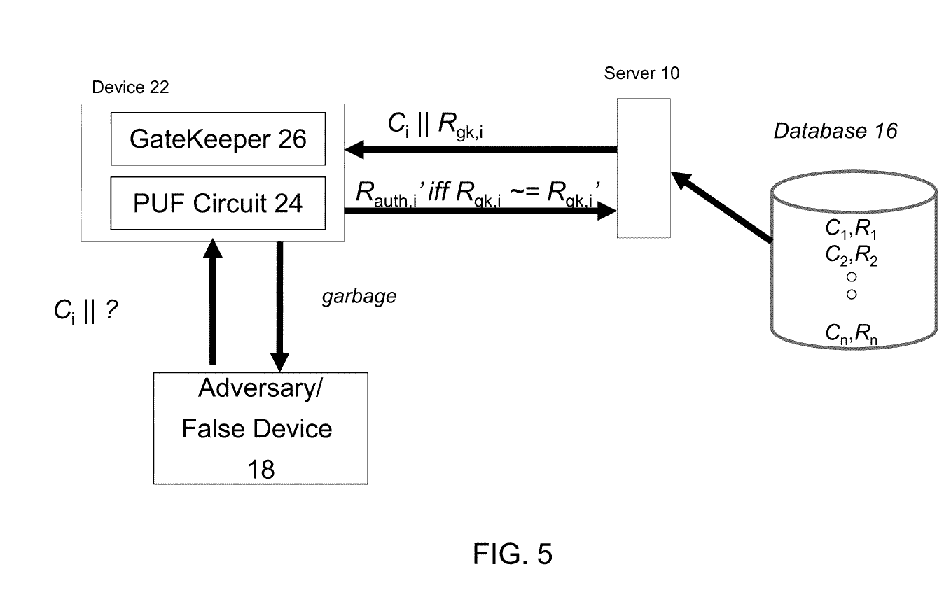

Referring now to FIG. 3, FIG. 4, and FIG. 5, an authentication system is shown for authentication that includes the server 10, the database 16, the device 22 in accordance with the various aspects of the invention. The system is also shown being attacked by the adversary 18. During authentication, beginning at step 310, the server 10 passes or sends to the device 22 a challenge {C₁, R_{gk1}}. In accordance with the aspects of the present invention, the server 10 should not reissue same challenge to authenticate to prevent replay attacks (or allow the probability of challenge collision to be sufficiently low for the security requirement of a given application). The device 22, at step 410, receives the challenge {C₁, R_{gk1}}. At step 412, the device 22 compares the incoming challenge {C₁, R_{gk1}} to a new evaluation R_{gk1}′=PUF_{gk}(C1). At step 414, device 22 determines if R_{gk1}′ and R_{gk1} is “close enough” in order to authenticate the server 10 to the device 22. If yes, then the process moves to step 416 and the gate function is enabled. Then the device 22, at step 418, transmits a respond with Rₐᵤₜₕ₁^{′}32 PUFauth(C1) and the authentication process at the device 22 ends at step 424. If the adversary 18 is attempting to access the device 18, then at step 414 the device 22 determines that R_{gk1}′ and R_{gk1} are no “close enough” to authenticate the adversary 18 to the device 22 and the process moves to step 420 because the adversary 18 is attempting an attack as a false or fake server. At step 422, the device 22 determines that the challenge is from the adversary 18 and provides an invalid or garbage response and the process ends at step 424. The server 10 compares the incoming Rₐᵤₜₕ₁′ against the provisioned Rₐᵤₜₕ₁ to authenticate the device.

In accordance with some aspects and embodiments of the present invention, a separate Gatekeeper and PUF circuit are shown for clarity. In accordance with one aspect of the present invention, the two may be merged by a creative choice of a challenge schedule. In accordance with the various aspects of the present invention, the challenges of the two modules to be interlocked in a manner that prevents chaining or other related attacks. Further, by using offline authentication modality, challenge/response pairs need not to be explicitly stored. Further, the provisioning server and local authentication server need not to be the same entity.

In accordance with some aspects and embodiments, a partial database can be generated by the provisioning a server to different authentication parties to allow each of them, who may not trust each other, to perform independent cross-audit functions of the authentication. The partial database can be derived from explicit challenge/response pairs collected, or can be synthesized from PUF parameters corresponding to the offline authentication method. The method is not limited to an Arbiter PUF but to almost any PUF having challenge/response characteristics, including Ring Oscillator constructions, and non-silicon physical functions that has a challenge/response evaluation mechanism in general.

In accordance with some aspects and embodiments, the gating function and the gatekeeper are at the device level, either as Simple Gating PUF mechanism or in combination with a Double Gating primitive. If a PUF authentication primitive is integrated in a device, such as device 22, be it a mobile device such as a smart phone or any system with some basic logic and a PUF authentication mechanism, and the process on the device is gated by the result of the authentication; then the process for the protocol is the following: the device starts process A that requires a PUF authentication; the device queries the PUF authentication mechanism before starting the process; IF the PUF authentication is validated, the process is started and IF NOT, the process is aborted. In accordance with some aspects and embodiments, the PUF authentication mechanism could be embedded in the device itself. In accordance with some other aspects and embodiments the PUF authentication mechanism is implemented in a separate device (such as a token) that can communicate with the primary device. Thus, unless the gate is open or enabled (i.e. the authentication is successful) the process making the query will not release any information and abort, thereby preventing attack from an adversary or false device.

In accordance with some aspects and embodiments, the GateKeeper+PUF circuit are defined as a full hardware solution. In accordance with some aspects and embodiments, use the PUF Circuit as a gating component as a combination of hardware and software to build a hybrid solution. Thus, it will apparent to one skilled in the art that the scope of the present invention is not limited by the hardware or software solutions and in accordance with the aspects and embodiments of the present invention, the system can define GateKeeper +PUF circuit as a PUF Gating or gatekeeper component/module, wherein the components are separate or merged.

In accordance with some aspects and embodiments, the gating function is to put the control at the server level. In this case, the use of the PUF circuit as a gating function is to prevent the execution of a transaction and provide a process for the release of any information, based on the authentication status after a query.

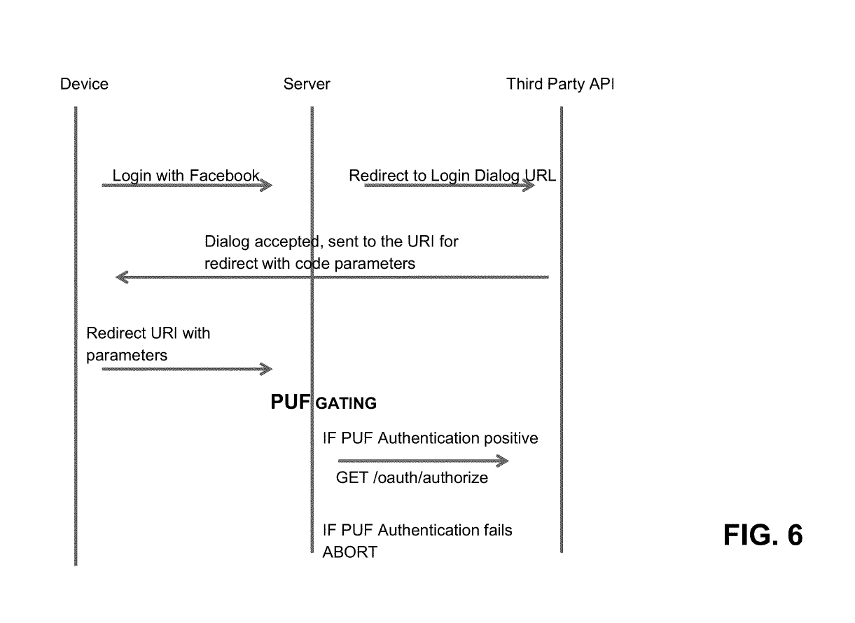

Referring now to FIG. 6, a data flow is shown in accordance with some aspects and embodiments, wherein the use of the PUF circuit as a gating function is also applicable to the context of a delegation of authority, that is a 3^{rd} party server can be used to get/provide an authorization, the right to perform an action, etc., which can be consumed by various services. For example, the concept of Login delegation, using a service such as Facebook or other authentication delegation services such as for instance systems implementing OpenID or variations of it.

In accordance with some aspects and embodiments, the use of a gating function at the Server level is two-fold: (1) a sub-system of the PUF circuit+GateKeeper as described locally implemented as a hardware module and as part of the server architecture; and/or (2) the PUF circuit+GateKeeper could be implemented at the Device level and the authentication performed with another (authentication) server, the result (or response) being forwarded as a signed response (classical delegation mechanism) to the Server controlling the gating function/mechanism with the Third Party service.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible. Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

What is claimed is:

1. A system comprising
a module for executing a gatekeeper function that produces a gatekeeper result in response to a challenge;
a module for executing an authentication function that produces an authentication response to a challenge based on the gatekeeper result; and
interlocking control module in communication with the module for executing the gatekeeper function and the module for executing the authentication function, such that the gatekeeper function determines access to the authentication function based on verification of the gatekeeper result.

2. A device comprising at least one of a processors, programmable logic and a full-custom device, wherein the device includes at least code or state machine to at least perform the following steps:
receive a challenge from a server;
produce a response that includes a gatekeeper response and a PUF response; and
transmit the response to the server.

3. A server comprising:
at least one of a processor and programmable logic serving similar function;
a communication module controlled by the processor or programmable logic; and
at least one memory including code, wherein the at least one memory and the code are configured to, with the at least one processor or programmable logic, cause the apparatus to at least perform the following steps:
generate a challenge
transmit the challenge, using the communication module, to a device;
receive a response to the challenge, through the communication module, from the device, wherein the response includes a gatekeeper response and a PUF response that is stored with the challenge as a triplet.
